(19) United States
(12) Patent Application Publication
(10) Pub. No.: US 2017/0048612 A1
(43) Pub. Date: Feb. 16, 2017

(54) ACOUSTICAL WAVEGUIDE

(71) Applicant: WOOX INNOVATIONS BELGIUM NV, Leuven (BE)

(72) Inventors: Aymeric DEVERGIE, Leuven (BE); Kelvin GRIFFITHS, Leuven (BE)

(21) Appl. No.: 15/306,492

(22) PCT Filed: Apr. 25, 2014
(86) PCT No.: PCT/EP2014/058463

§ 371 Date: Oct. 25, 2016

(51) Int. Cl. H04R 1/34; H04R 1/30

(52) U.S. Cl. CPC H04R 1/345; H04R 1/30

(57) ABSTRACT

The present invention provides, in a first aspect, an acoustical waveguide, and in a second aspect, a soundbar comprising the acoustical waveguide of the first aspect. The acoustical waveguide comprises a throat for receiving sound from a sound source. The throat has a first throat width. The acoustical waveguide further comprises a mouth through which the sound received at the throat exits. The mouth has a first mouth width coplanar with and narrower than the first throat width.

### FIELD OF THE INVENTION

The present invention relates generally to acoustical waveguides. The present invention is described herein primarily in relation to acoustical waveguides for cinematic sound systems, but is not limited to this particular application.

### BACKGROUND

Home cinema soundbars are a fast growing product segment. Such soundbars produce sound which is of a better quality than that produced by built-in television speakers. These soundbars also have compact footprints and are easy to set up.

Prior soundbars, however, have the disadvantage that they do not produce the immersive and enveloping sound typically produced by multi-channel home cinema systems that provide a wide front stage and real surround sound. In an attempt to address this disadvantage, sound processing and acoustical devices can be used to create a more immersive sound experience than what otherwise would have been produced by a soundbar of a bigger size or a non-slim design.

For example, this improved sound experience can be achieved by beaming sound energy towards the side walls of a room, but at the same time preventing this sound energy from being beamed directly to a listener. As a consequence, the listener will hear the reflected from the side walls, and hence will perceive the sound as wider than what the width of the soundbar would normally achieve without this technique of beaming sound energy towards the side walls.

However, a loudspeaker driver in general and a high frequency tweeter in particular have an omnidirectional behavior in the frequency range of interest. That is to say, they radiate sound in all directions away from the front of the loudspeaker, and in doing so, they radiate sound in each direction with energy of the same order of magnitude. This omnidirectional behavior hampers the efficacy of the technique of beaming sound energy towards side walls of a room as described above, and therefore, detracts from the improved immersive sound experience desired.

It is an object of the present invention to overcome or ameliorate at least one of the disadvantages of the prior art, or to provide a useful alternative.

### SUMMARY

The present invention, in a first aspect, provides an acoustical waveguide comprising:
a throat for receiving sound from a sound source, the throat having a first throat width; and
a mouth through which the sound received at the throat exits, the mouth having a first mouth width coplanar with and narrower than the first throat width.

In one embodiment, the first mouth width is less than 10 mm. In one embodiment, the throat is circular and the first throat width is a diameter of the circular throat.

In one embodiment, the throat has a second throat width perpendicular to the first throat width and the mouth has a second mouth width perpendicular with the first mouth width, the second mouth width being wider than the second throat width. In one embodiment, the second mouth width is selected to provide a desired low-frequency cutoff. In one embodiment, the second mouth width is equal to or greater than 60 mm. In one embodiment, the throat is circular and the first and second throat widths are diameters of the circular throat, and are thereby equal.

In one embodiment, the acoustical waveguide has a centre length between a centre of the throat and a centre of the mouth, and a coverage angle in accordance with the following equation:

φ=arctan((WM2−WT2)/(2*L))*(180/π)

where:
φ is the coverage angle;
WM2 is the second mouth width;
WT2 is the second throat width; and
L is the centre length.

In one embodiment, the coverage angle is equal to or less than 15 degrees.

In one embodiment, the mouth is rectangular. In one embodiment, one or more or all edges of the mouth are smooth.

In one embodiment, the acoustical waveguide comprises a waveguide tube having two open ends and one or more sidewalls between the open ends, the throat being one of the open ends and the mouth being the other of the open ends, wherein the sidewalls are straight.

In one embodiment, the sound radiates from the mouth in a radiation pattern having a cross-section in a plane perpendicular to the first mouth width resembling a fan shape, the fan shape expanding away from the mouth, the radiation pattern being relatively narrow across the first mouth width.

In one embodiment, the sound is in a high audio frequency range. In one embodiment, the sound source is a tweeter loudspeaker.

In one embodiment, the first mouth width is oriented horizontally. In one embodiment, the mouth is oriented to project the sound received at the throat to a side of a listener in a normal seating position. In one embodiment, the mouth is oriented to project the sound received at the throat to a wall positioned at a side of a listener in a normal seating position such that the sound reflects off the wall and travels to the listener.

In one embodiment, the acoustical waveguide is part of a soundbar. In one embodiment, the soundbar comprises a central loudspeaker and two lateral loudspeakers, one on either side of the central loudspeaker, the acoustical waveguide receiving sound from one of the lateral loudspeakers, the soundbar comprising a second said acoustical waveguide that receives sound from the other of the lateral loudspeakers. In one embodiment, the mouth of one of the acoustical waveguides is oriented to face towards a left side of the soundbar away from the central loudspeaker, and the mouth of the other of the acoustical waveguides is oriented to face towards a right side of the soundbar opposite to the left side and away from the central loudspeaker. In one embodiment, the lateral loudspeakers are tweeter loudspeakers.

In a second aspect, the present invention provides a soundbar comprising an acoustical waveguide as described above.

In one embodiment, the soundbar comprises a central loudspeaker and two lateral loudspeakers, one on either side of the central loudspeaker, the acoustical waveguide receiving sound from one of the lateral loudspeakers, the soundbar comprising a second said acoustical waveguide that receives sound from the other of the lateral loudspeakers. In one embodiment, the mouth of one of the acoustical waveguides is oriented to face towards a left side of the soundbar away from the central loudspeaker, and the mouth of the other of the acoustical waveguides is oriented to face towards a right side of the soundbar opposite to the left side and away from the central loudspeaker. In one embodiment, the lateral loudspeakers are tweeter loudspeakers.

It will be appreciated that the features above may be combined in various combinations in various embodiments of the present invention.

Throughout this specification, including the claims, the words “comprise”, “comprising”, and other like terms are to be construed in an inclusive sense, that is, in the sense of “including, but not limited to”, and not in an exclusive or exhaustive sense, unless explicitly stated otherwise or the context clearly requires otherwise.

### BRIEF DESCRIPTION OF THE FIGURES

Preferred embodiments in accordance with the best mode of the present invention will now be described, by way of example only, with reference to the accompanying figures, in which:

FIG. 1 is a perspective view of an acoustical waveguide in accordance with an embodiment of the present invention;

FIG. 2 is a top view of the acoustical waveguide shown in FIG. 1 when viewed from position A as indicated in FIG. 1;

FIG. 3 is a front view of the acoustical waveguide shown in FIG. 1 when viewed from position B as indicated in FIG. 1;

FIG. 4 is a back view of the acoustical waveguide shown in FIG. 1 when viewed from position C as indicated in FIG. 1;

FIG. 5 is a perspective view of a soundbar in accordance with an embodiment of the present invention;

FIG. 6 is a front view of the soundbar shown in FIG. 5 when viewed from position D as indicated in FIG. 5;

FIG. 7 is a bottom view of the soundbar shown in FIG. 5 when viewed from position E as indicated in FIG. 5;

FIG. 8 is a left side view of the soundbar shown in FIG. 5 when viewed from position F as indicated in FIG. 5;

FIG. 9 is a right side view of the soundbar shown in FIG. 5 when viewed from position G as indicated in FIG. 5;

FIG. 10 is a front view of the soundbar shown in FIG. 5 when viewed from position D as indicated in FIG. 5, with the internal components of the soundbar shown; and

FIG. 11 is a bottom view of the soundbar shown in FIG. 5 when viewed from position E as indicated in FIG. 5, with the internal components of the soundbar shown.

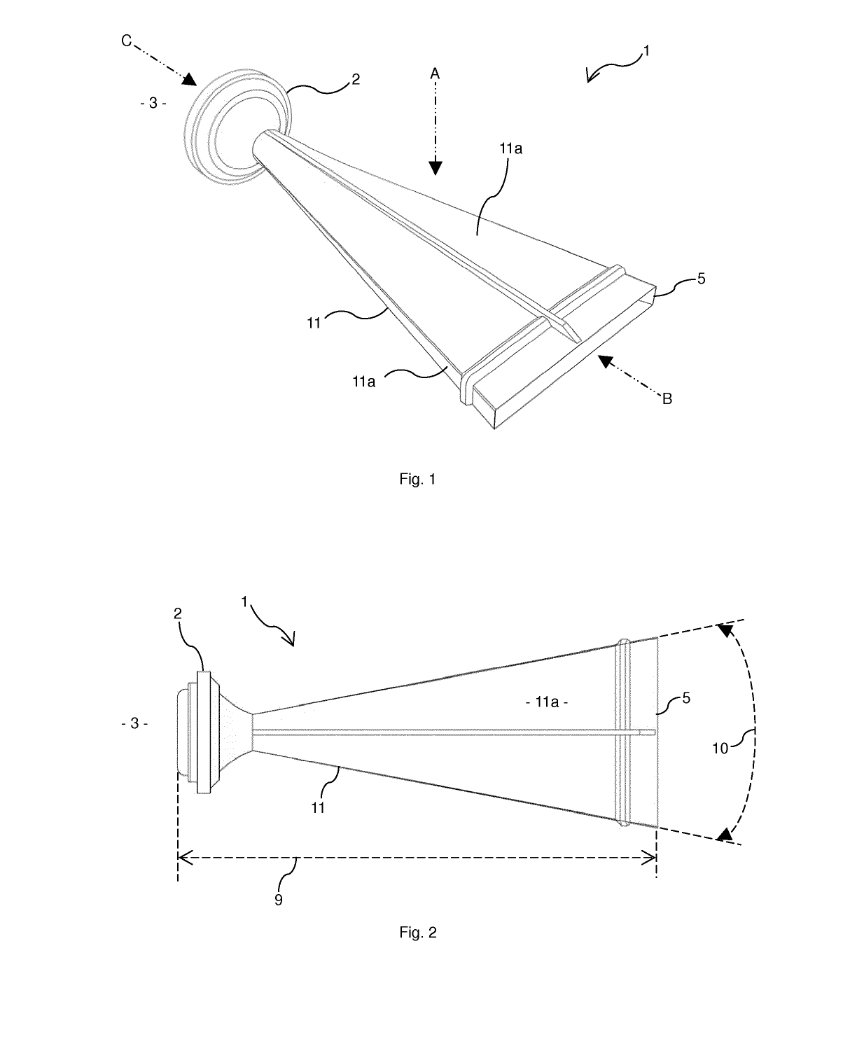

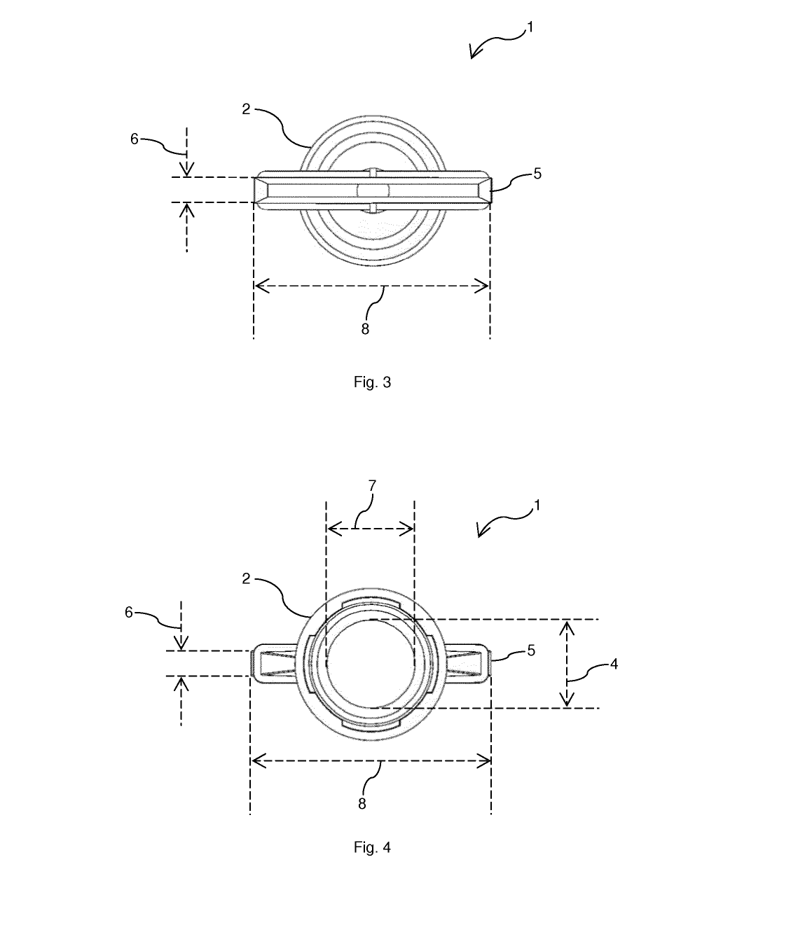

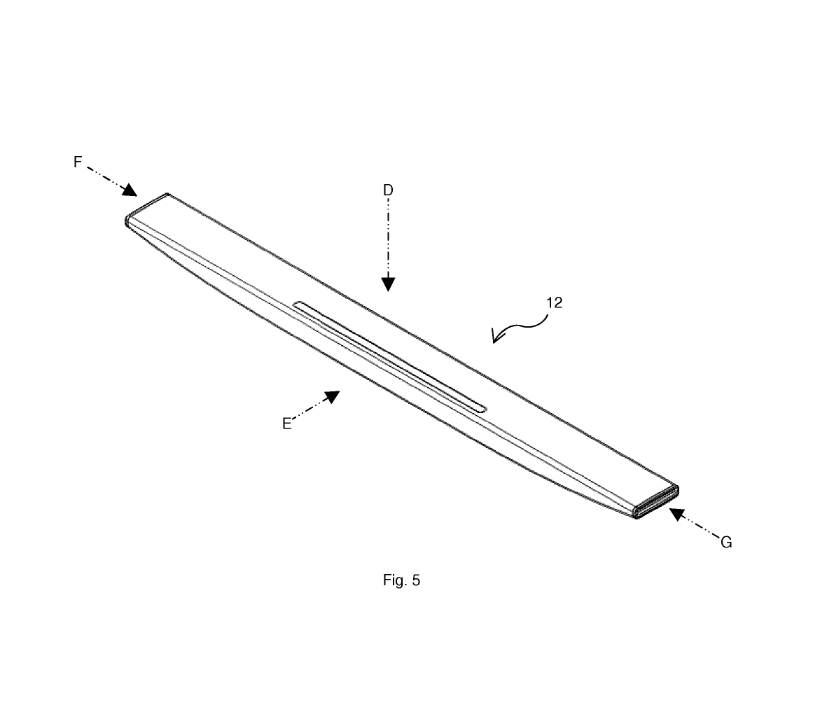

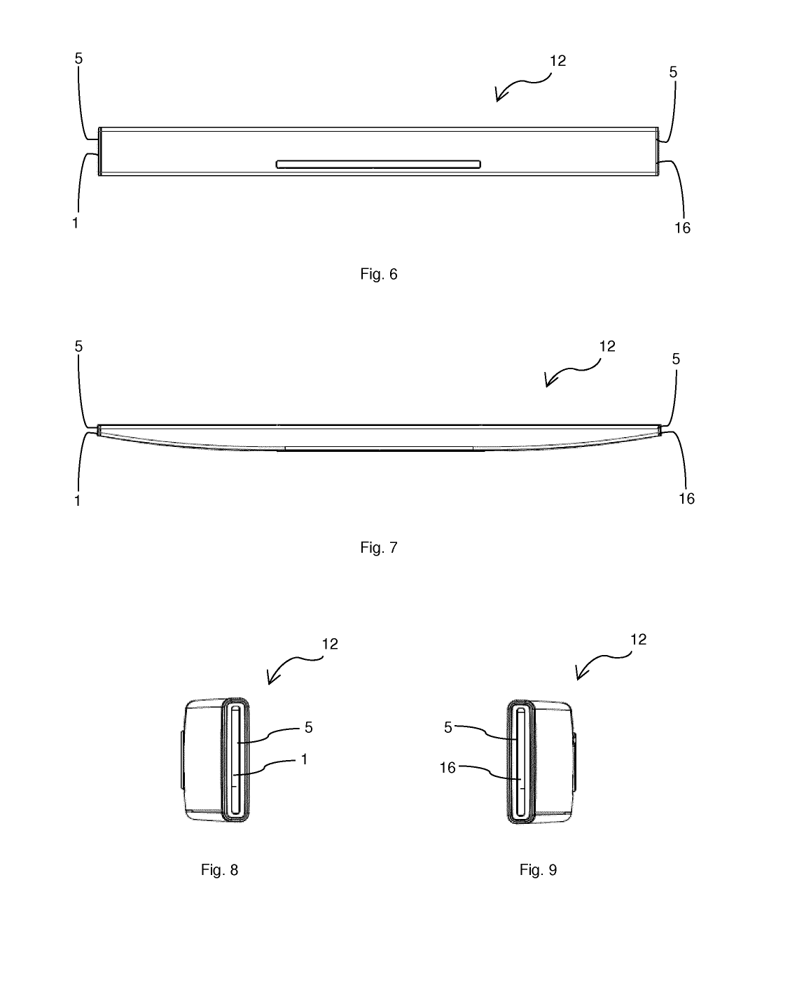

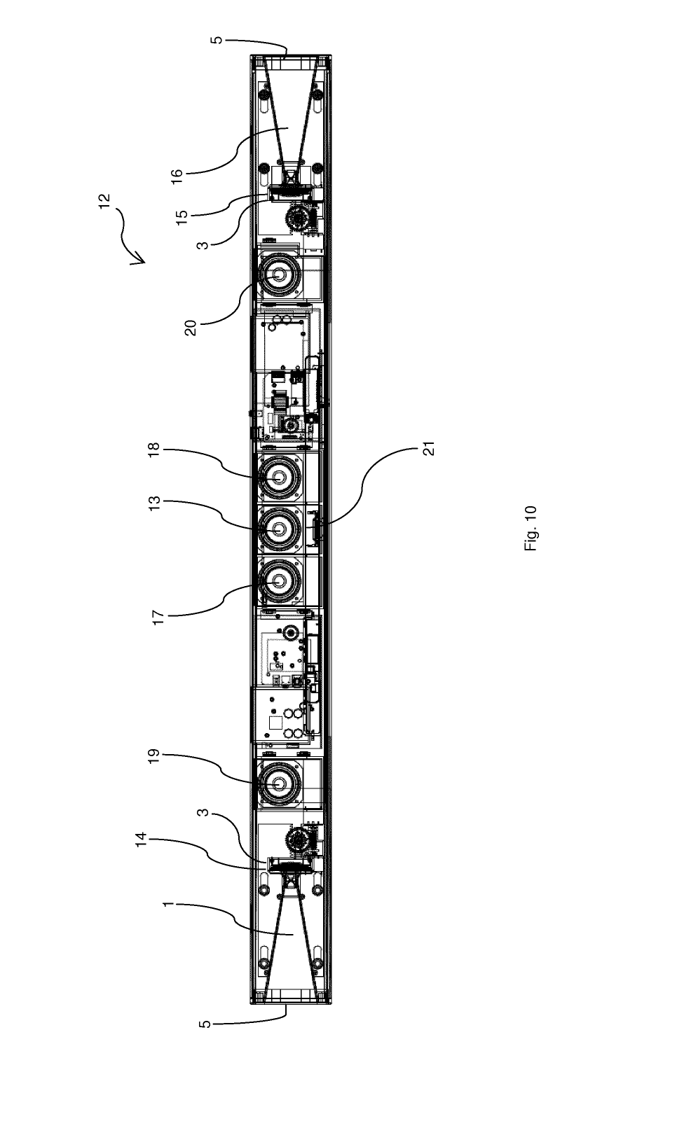

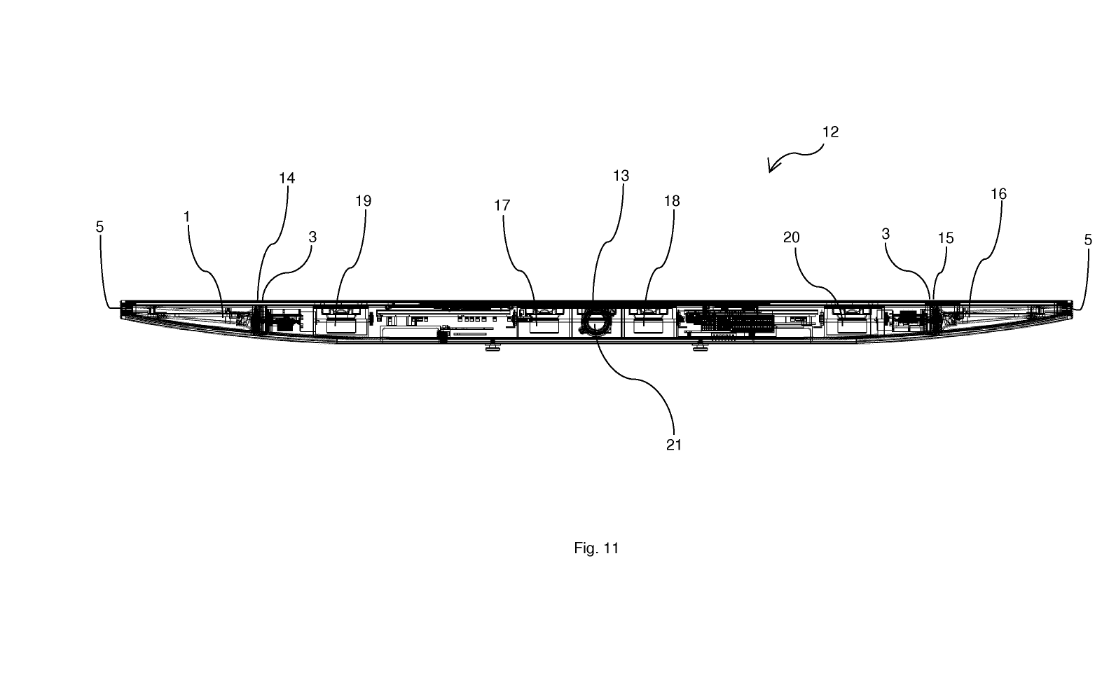

### DETAILED DESCRIPTION

Referring to the figures, the present invention, in a first aspect, provides an acoustical waveguide 1. The acoustical waveguide 1 comprises a throat 2 for receiving sound from a sound source 3. The throat 2 has a first throat width 4. The acoustical waveguide 1 further comprises a mouth 5 through which the sound received at the throat 2 exits. The mouth 5 has a first mouth width 6 coplanar with and narrower than the first throat width 4.

By having the first mouth width 6 narrower than the first throat width, the sound exits the mouth 5 as a very narrow beam across the first mouth width 6. The actual magnitude of the first mouth width 6 is selected depending on the requirements of each particular application. However, it has been found that having a first mouth width 6 that is less than 10 mm provides good performance, especially in distributing the sound energy in one plane, and especially when used in home cinema sound systems.

In the present embodiment, the throat 2 is circular and the first throat width 4 is a diameter of the circular throat. However, the invention is not limited to circular throats, and in other embodiments, the throat can be a variety of different shapes. Often, the shape of the throat 2 is dictated by the shape of the face of the sound source 3 since the throat typically fits over the face of the sound source 2. For example, a circular throat 2 is typically required for a loudspeaker having a circular face.

In the present embodiment, the throat 2 has a second throat width 7 perpendicular to the first throat width 4 and the mouth 5 has a second mouth width 8 perpendicular with the first mouth width 6, and the second mouth width 8 is wider than the second throat width 7. The second mouth width 8 determines the low-frequency cutoff of the acoustical waveguide 1. Therefore, the second mouth width 8 is selected to provide a desired low-frequency cutoff. The actual magnitude of the second mouth width 8 therefore depends on the requirements of each particular application. However, it has been found that having a second mouth width 8 that is equal to or greater than 60 mm provides good performance, especially in narrowing the beam of sound directed to the desired destination, such as a side wall of a room, and especially in the context of home cinema sound systems.

Since in the present embodiment the throat 2 is circular, the first throat width 4 and the second throat width 7 are equal, with both being diameters of the circular throat.

The acoustical waveguide 1 has a centre length 9 between a centre of the throat 2 and a centre of the mouth 5. A coverage angle 10 can be defined in accordance with the following equation:

φ=arctan((W_{M2}−W_{T2})/(2*L))*(180/π)

where:
φ is the coverage angle 10;
W_{M2} is the second mouth width 8;
W_{T2} is the second throat width 7; and
L is the centre length 9.

Therefore, for example, with a desired coverage angle 10, a desired centre length 9, and a known second throat width 7, the required second mouth width 8 can be calculated. Alternatively, with a desired coverage angle 10 and a known second throat width 7, a set of possible centre lengths 9 and corresponding second mouth widths 8 can be calculated. Often, the second throat width 7 is dictated by the dimensions of the sound source 3 over which the throat 2 fits. A coverage angle 10 of equal to or less than 15 degrees has been found to provide good performance, especially in the context of home cinema sound systems.

It has been found that increasing the centre length 9 increases the modal density and at the same time lowers the operable frequency of the acoustical waveguide 1. Increasing the first mouth width 6 increases the directivity of the sound in a plane along the first mouth width 6. Both a high modal density and high directivity are desirable so the ratio between the second mouth width 8 and the centre length 9 needs to be balanced. Increasing the first mouth width 6 and the second mouth width 8 independently increases the directivity in the plane of the first mouth width 6 and in the plane of the second mouth width 8 respectively. Decreasing the first mouth width 6 and the second mouth width 8 independently decreases the directivity in the plane of the first mouth width 6 and in the plane of the second mouth width 8 respectively. The resulting mouth aspect ratio, that is, the ratio between the first mouth width 6 and the second mouth width 8 determines the amount of directivity and the operational frequency range. In other words, the smaller a dimension is, the less directivity results along that dimension. Thus, sound waves radiating from an opening with a small dimension are spread-out and diffused along that small dimension. Conversely, the larger a dimension is, the more directivity results along that dimension. Thus, sound waves radiating from an opening with a large dimension are focused and concentrated along that dimension.

In the present embodiment, the mouth 5 is rectangular. The first mouth width 6 is the minor dimension of the rectangular mouth 5, whilst the second mouth width 8 is the major dimension of the rectangular mouth 5. The acoustical waveguide 1 is oriented so that the first mouth width 6 is horizontal.

The sound radiates from the mouth 5 in a radiation pattern having a cross-section in a plane perpendicular to the first mouth width 6 resembling a fan shape, with the fan shape expanding away from the mouth 5. The radiation pattern is relatively narrow across the first mouth width 6. Since the acoustical waveguide 1 is oriented so that the first mouth width 6 is horizontal, the fan-shaped cross-section of the radiation pattern is vertical.

The acoustical waveguide 1 comprises a waveguide tube (horn) 11 having two open ends and one or more sidewalls 11a between the open ends. The throat 2 is one of the open ends and the mouth 5 is the other of the open ends. The sidewalls 11a are preferably straight. In acoustical horn terminology, this is analogous to a conical horn.

The features described above of the acoustical waveguide 1 allow the acoustical waveguide to effectively transform the omnidirectional sound radiation pattern from a loudspeaker into a directional sound radiation pattern. The acoustical waveguide 1 therefore acts as a “directivity converter” that concentrates sound energy from a loudspeaker into a specific direction, so that a higher proportion of the total sound energy from the loudspeaker radiates in that specific direction compared with the sound energy radiating in all other directions.

This makes the acoustical waveguide 1 much more effective in, for example, beaming sound energy towards the side walls of a room, but at the same time preventing this sound energy from being beamed directly to a listener. When incorporated in soundbars, acoustical waveguides of the present invention such as the acoustical waveguide 1 are very effective in creating the perception that the soundbar provides a wider sound than what the soundbar would normally provide without the acoustical waveguides 1. In such applications generally, the mouth 5 is oriented to project the sound received at the throat 2 to a side of a listener in a normal seating position. More particularly, the mouth 5 is oriented to project the sound received at the throat 2 to a wall positioned at a side of a listener in a normal seating position such that the sound reflects off the wall and travels to the listener.

The acoustical waveguide 1 is particularly useful when the sound is at a high audio frequency, for example, when the sound source 3 is a tweeter loudspeaker. It has been found that high audio frequencies play an important role in the perception of sound width since high audio frequencies provide localization cues for the human auditory perception system. Thus, when used with high frequency sound, and with the mouth 5 oriented to the side of a listener or to a wall positioned at a side of a listener, the acoustical waveguide 1 is highly effective in creating a wider perceived sound than what would normally be perceived without the acoustical waveguide.

The acoustical waveguide 1 can also be used in other 3-dimensional sound products.

The present invention, in a second aspect, also provides a soundbar 12 comprising the acoustical waveguide 1.

The soundbar 12 generally comprises a central loudspeaker 13 and two lateral loudspeakers 14 and 15, one on either side of the central loudspeaker, and a second acoustical waveguide 16 in accordance with the first aspect of the present invention as described above. In the present embodiment, the second acoustical waveguide 16 is identical to the acoustical waveguide 1. The acoustical waveguide 1 receives sound from one of the lateral loudspeakers 14, and the second acoustical waveguide 16 receives sound from the other of the lateral loudspeakers 15. The lateral loudspeakers 14 and 15 are tweeter loudspeakers. The central loudspeaker 13 is front facing, and faces towards a listener in a normal seating position.

The mouth 5 of one of the acoustical waveguides 1 is oriented to face towards a left side of the soundbar 12 away from the central loudspeaker 13, and the mouth 5 of the other of the acoustical waveguides 16 is oriented to face towards a right side of the soundbar 12 opposite to the left side and away from the central loudspeaker 13. As noted above, each acoustical waveguide 1 and 16 is oriented so that the first mouth width 6 is horizontal, and the sound radiates from the mouth in a radiation pattern that has a fan-shaped cross-section in a vertical direction.

In the present embodiment, the soundbar also comprises two further front-facing loudspeakers 17 and 18 in a centre portion of the soundbar 12 closely adjacent either side of the central loudspeaker 13. An additional two front-facing outboard loudspeakers 19 and 20 are positioned either side of the three loudspeakers 13, 17, and 18 centrally located in the centre portion of the soundbar 12. These additional two front-facing outboard loudspeakers 19 and 20 are spaced from the three centrally located loudspeakers 13, 17, and 18 towards either end of the soundbar 12. Finally, the soundbar includes a downwardly facing loudspeaker 21 in the centre portion.

However, it is appreciated that soundbars of the present invention can have any number of loudspeakers in a variety of configurations depending on the particular design requirements. The loudspeakers can be of different types, such as loudspeakers for producing mid-range audio frequencies, woofers, sub-woofers, tweeters, and super-tweeters. Also, different loudspeakers or different combinations of loudspeakers can produce sound from different stereo channels of a sound system. For example, the soundbar 12 can have three front-facing mid-range loudspeakers 13, 17, and 18 in the centre portion of the soundbar, two front-facing mid-range outboard loudspeakers 19 and 20 positioned either side of and spaced apart from the centrally located mid-range loudspeakers, one downwardly facing tweeter 21 in the centre portion, and two side facing tweeters 14 and 15 on either end of the soundbar. The two side facing tweeters 14 and 15 each connected to a respective acoustical waveguide 1 and 16 in accordance with the present invention. The outboard loudspeaker 19 and the tweeter 14 on the same side of the soundbar 12 produces sound from one stereo channel, and the outboard loudspeaker 20 and the tweeter 15 on the other side of the soundbar 12 produces sound from a second stereo channel.

It can be appreciated that the aforesaid embodiments are only exemplary embodiments adopted to describe the principles of the present invention, and the present invention is not merely limited thereto. Various variants and modifications may be made by those of ordinary skill in the art without departing from the spirit and essence of the present invention, and these variants and modifications are also covered within the scope of the present invention. Accordingly, although the invention has been described with reference to specific examples, it can be appreciated by those skilled in the art that the invention can be embodied in many other forms. It can also be appreciated by those skilled in the art that the features of the various examples described can be combined in other combinations.

1. An acoustical waveguide comprising:
a throat for receiving sound from a sound source, the throat having a first throat width; and
a mouth through which the sound received at the throat exits, the mouth having a first mouth width coplanar with and narrower than the first throat width.

2. An acoustical waveguide according to claim 1 wherein the first mouth width is less than 10 mm.

3. An acoustical waveguide according to claim 1 wherein the throat is circular and the first throat width is a diameter of the circular throat.

4. An acoustical waveguide according to claim 1 wherein the throat has a second throat width perpendicular to the first throat width and the mouth has a second mouth width perpendicular with the first mouth width, the second mouth width being wider than the second throat width.

5. An acoustical waveguide according to claim 4 wherein the second mouth width is selected to provide a desired low-frequency cutoff.

6. An acoustical waveguide according to claim 4 wherein the second mouth width is equal to or greater than 60 mm.

7. An acoustical waveguide according to claim 4 wherein the throat is circular and the first and second throat widths are diameters of the circular throat, and are thereby equal.

8. An acoustical waveguide according to claim 4 having a centre length between a centre of the throat and a centre of the mouth, and a coverage angle in accordance with the following equation:
φ=arctan((W_{M2}−W_{T2})/(2*L))*(180/π)
where:
φ is the coverage angle;
W_{M2} is the second mouth width;
W_{T2} is the second throat width; and
L is the centre length.

9. An acoustical waveguide according to claim 8 wherein the coverage angle is equal to or less than 15 degrees.

10. An acoustical waveguide according to claim 1 wherein the mouth is rectangular.

11. (canceled)

12. An acoustical waveguide according to claim 1 wherein the sound radiates from the mouth in a radiation pattern having a cross-section in a plane perpendicular to the first mouth width resembling a fan shape, the fan shape expanding away from the mouth, the radiation pattern being relatively narrow across the first mouth width.

13. An acoustical waveguide according to claim 1 wherein the sound is at a high audio frequency.

14. An acoustical waveguide according to claim 1 wherein the sound source is a tweeter loudspeaker.

15. An acoustical waveguide according to claim 1 wherein the first mouth width is oriented horizontally.

16. An acoustical waveguide according to claim 1 wherein the mouth is oriented to project the sound received at the throat to a side of a listener in a normal seating position.

17. An acoustical waveguide according to claim 1 wherein the mouth is oriented to project the sound received at the throat to a wall positioned at a side of a listener in a normal seating position such that the sound reflects off the wall and travels to the listener.

18. An acoustical waveguide according to claim 1 wherein the acoustical waveguide is part of a soundbar.

19. An acoustical waveguide according to claim 18 wherein the soundbar comprises a central loudspeaker and two lateral loudspeakers, one on either side of the central loudspeaker, the acoustical waveguide receiving sound from one of the lateral loudspeakers, the soundbar comprising a second said acoustical waveguide that receives sound from the other of the lateral loudspeakers.

20. An acoustical waveguide according to claim 19 wherein the mouth of one of the acoustical waveguides is oriented to face towards a left side of the soundbar away from the central loudspeaker, and the mouth of the other of the acoustical waveguides is oriented to face towards a right side of the soundbar opposite to the left side and away from the central loudspeaker.

21. An acoustical waveguide according to claim 19 wherein the lateral loudspeakers are tweeter loudspeakers.

22. (canceled)

23. (canceled)

24. (canceled)

25. (canceled)
